(19) United States
(12) Patent Application Publication
(10) Pub. No.: US 2008/0005222 A1
(43) Pub. Date: Jan. 3, 2008

(54) System and Method for Server Information Handling System Management Through Local I/O Devices

(76) Inventors: Timothy M. Lambert, Austin, TX (US); Pedro Lopez, Austin, TX (US)

Correspondence Address: HAMILTON & TERRILE, LLP, P.O. BOX 203518, AUSTIN, TX, 78720, US

(21) Appl. No.: 11/422,628

(22) Filed: Jun. 7, 2006

(51) Int. Cl. G06F 15/16

(52) U.S. Cl. 709/203

(57) ABSTRACT

A server information handling system integrated management controller selectively communicates management information between a baseboard management controller and either a network remote console session or local I/O devices, such as a display, a keyboard, a mouse or a KVM appliance. Display information is communicated from the baseboard management controller to a display by writing from the baseboard management controller through a unified memory controller to a display frame buffer for presentation at the display. Keyboard, mouse and KVM information is communicated through a USB host to the baseboard management controller or, in an operational state, is communicated from the USB host to a USB client for use by the server information handling system. In an operational state, a break sequence selectively interfaces the I/O devices with the server information handling system or the baseboard management controller.

### BACKGROUND OF THE INVENTION

1. Field of the Invention

The present invention relates in general to the field of server information handling systems, and more particularly to a system and method for server information handling system management through local I/O devices.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In many ways, increased reliance on information handling systems by businesses and individuals has resulted from improved abilities to share information between systems through networks. Typically, one or more server information handling systems lies at the heart of each network to coordinate the communication of information to client information handling systems. For example, a blade server information handling system has plural blade systems to process information within a common chassis having common power and cooling subsystems. Generally, server information handling systems are configured to perform tasks with minimal direct inputs from users, such as from information technology administrators. Since server information handling systems are often left to run without direct user interaction, they are often set up with remote management systems, such as an Integrated Management Controller (IMC) having a Baseboard Management Controller (BMC), VGA controller, remote virtual keyboard, visual, mouse (KVM) module and virtual media functions. Thus, for instance, a server may be remotely started or shut down through a network interface supported by the IMC. The IMC typically includes a unified memory controller that allows the BMC firmware, KVM module and VGA frame buffer functions to share a unified memory device, thus driving down motherboard costs while providing mandatory and optional server management functions in all server motherboards.

Generally, in order to communicate with a BMC before a server information handling system has power (i.e., under auxiliary power), an information technology administrator has to interface with the BMC through “out of band” hooks, such as serial, dedicated or shared management network interface cards (NICs). Although network out of band interfaces through the BMC make sense when input/output (I/O) devices, such as a keyboard, mouse and display, are remotely located from the server information handling system, network out of band interfaces are sometimes a hassle when the I/O devices are collocated with the server information handling system. For instance, information technology administrators sometimes prefer to manage a server information handling system from a local or remote KVM appliance rather than connecting to another interface to communicate with the management subsystem. For example, information technology administrators may prefer to manage blades of a common blade information handling system chassis through a single interface instead of through serial interfaces or management networks in a pre-boot environment and then a KVM appliance during POST or under operating system control.

### SUMMARY OF THE INVENTION

Therefore a need has arisen for a system and method which selectively manages a server information handling system through local I/O devices or a management network while the server information handling system is in a powered down state, such as auxiliary power.

In accordance with the present invention, a system and method are provided which substantially reduce the disadvantages and problems associated with previous methods and systems for managing a server information handling system. Management of a server information handling system is selectively supported through a remote console session or local I/O devices with an integrated management controller that operates on auxiliary power with the server information handling system in a power down state. Once main power is applied to bring the server information handling system to an operational state, the local I/O devices selectively interface with the IMC or with the processing unit of the server information handling system by input of a break sequence.

More specifically, an integrated management controller includes a baseboard management controller, display module, input device host, input device client and unified memory. An I/O device manager selectively interfaces I/O devices based on one or more predetermined factors. In a powered down state, either a remote console session or local I/O devices are interfaced with the baseboard management controller. A display device interfaces with the baseboard management controller by writes of management information from the baseboard management controller to the unified memory for access by the display module. An input device, such as a KVM appliance, keyboard or mouse, interfaces with the baseboard management controller through the input device host, such as a USB host. At power up of the server information handling system to an operational state, the local display presents information from the server's processing unit by discontinuing writes from the baseboard management controller to the display buffer in the unified memory and allowing writes from the processing unit to the display module. At power up to the operational state, inputs to the input device host are forward to the input device client for use by the processing unit. The inputs are monitored for a predetermined break sequence which commands alternatively management of the I/O devices by the baseboard management controller or the processing unit.

The present invention provides a number of important technical advantages. One example of an important technical advantage is that a server information handling system is managed in a power down state, such as auxiliary power or during early POST before video is initialized, with local I/O devices, such as a local keyboard, mouse and display, or a KVM session. BMC communication with a local keyboard, mouse and display is supported without any host server requirements, such as utilities, applications or even power. If the server information handling system is powered down, booting, or managed by an operating system, the I/O devices work as expected. At input of a break signal of a server information handling system under management of an operating system, the display presents a user interface for the BMC and the local keyboard and mouse interact with the BMC through the user interface. Another input of the break signal returns the display, keyboard and mouse to normal operating system control.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a server information handling system having an integrated management controller that selectively interfaces with local or remote I/O devices with the server information handling system in a powered down state;

FIG. 2 depicts a flow diagram of a process for selectively interfacing the local or remote I/O devices with the server information handling system in the powered down state; and

FIG. 3 depicts a flow diagram of a process for selectively interfacing the integrated management controller or the server information handling system with I/O devices with the server information handling system in an operational state.

### DETAILED DESCRIPTION

Selectively interfacing local I/O devices with a server information handling system integrated management controller provides increased flexibility by allowing an end user to manage the server information handling system in a powered down state with either a network remote console session or the local I/O devices. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

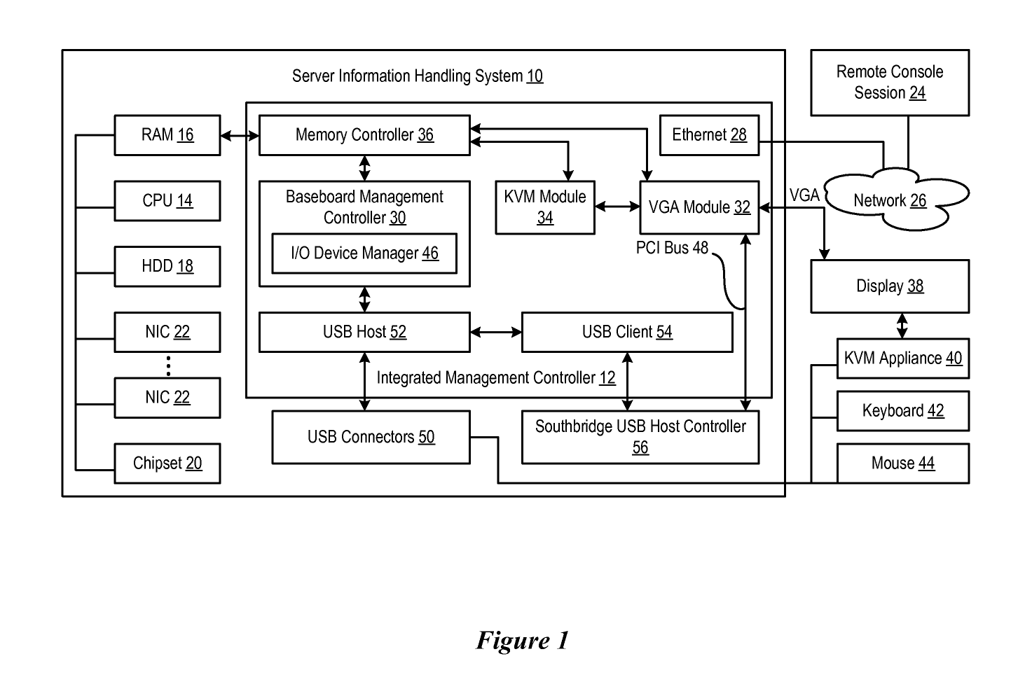

Referring now to FIG. 1, a block diagram depicts a server information handling system 10 having an integrated management controller (IMC) 12 that selectively interfaces with local or remote I/O devices with server information handling system 10 in a powered down state. Server information handling system 10 processes network information with plural processing components, such as a central processing unit (CPU) 14, RAM 16, a hard disk drive (HDD) 18, a chipset 20 and plural network interface cards (NICs) 22. The processing components operate with power from a primary power source while integrated management controller 12 operates with power from an auxiliary power source provided even when the server information handling system processing components are in a powered down state or other non-operational state, such as during POST before initiation of an operating system. With auxiliary power to integrated management controller 12, a user can manage power up of server information handling system 10 from a powered down state to an operating state from a remote location through an out-of-band interface. For example, a network remote console session 24 interfaced through a network 26 and an Ethernet connector 28 manages power up or power down of server information handling system 10 with a baseboard management controller (BMC) 30. BMC 30 is built on the same ASIC as other motherboard type of components in integrated management controller 12 to save space, to reduce expense and to operate more quickly and efficiently. For instance, as is depicted by FIG. 1, a VGA module 32 provides display functions, a KVM module 34 supports inputs from KVM devices and a unified memory controller 36 allows firmware operating on integrated management controller 12 to share a unified memory, such as RAM 16 of server information handling system 10 operating under auxiliary power.

Co-location in IMC 12 of VGA module 32, KVM module 34 and BMC 30 with each having access to common memory through memory controller 36 provides an architecture that supports interaction in a powered down state of both network remote console sessions 24 and local I/O devices, such as a display 38, a KVM appliance 40, keyboard 42 and mouse 44. An I/O device manager 46 running on IMC 12, such as in firmware of BMC 30, determines whether to interact through remote or local I/O devices. In a power down state before server information handling system 10 is operational, I/O device manager 46 determines whether user inputs originate from remote console session 24 or from KVM appliance 40, keyboard 42 and mouse 44 and to determine whether visual information is output at local display 32. In an operational state after POST with the operating system on line, I/O device manager 46 allows selective use of local I/O devices by server information handling system 10 or by BMC 30. For instance, during POST or after POST completes, I/O device manager 46 turns the interface with the local I/O devices over to CPU 14 and then monitors the input devices for a break sequence, such as a predetermined set of inputs at keyboard 42. Upon detection of the break sequence, BMC 30 reasserts control of the local I/O devices to allow direct user interaction with the BMC. Subsequent control of the local I/O devices is alternated between CPU 14 and BMC 30 at each detection of a break sequence.

Visual information generated by BMC 30 is available to drive a local display in the powered down state since VGA module 32 is in the same ASIC as BMC 30 and therefore powered by auxiliary power. IMC 12 has direct access through memory controller 36 of the area in RAM 16 used for the video frame buffer, typically about 8 MB for a VGA display core. In addition, IMC 12 has direct access to registers of display module 32 for configuration before the video BIOS executes. Thus, to present information at local display 38, BMC 30 writes through memory controller 36 directly to the frame buffer of display module 32, preempting frame buffer data that originates through PCI bus 48, so that management information generated at BMC 30 is driven to the local display interface, such as a VGA connector. For example, BMC 30 writes management information in a DOS style VGA screen for presentation of local LCD contents, system or sensor status, system event logs or any other information that usually requires communication with BMC 30 through a serial or NIC interface. Existing management function scripts, such as IPMI scripts, are, for instance, directly mapped to the local keyboard or mouse interface in the same manner as traditional interfaces.

Input management information to BMC 30 from KVM appliance 40, keyboard 42 or mouse 44 is managed in the powered down state by designating one or more external connectors, such as USB connectors 50, that normally connect to a host USB controller to instead connect to an IMC memory mapped USB host 52 built into IMC 12. Input devices connected to USB connectors 50 communicate management information directly to BMC 30 with server information handling system 10 in the powered down state. Once main power is applied, the input devices are automatically proxied by I/O device manager 46 between USB host 52 to a USB client 54 to connect through a southbridge USB host controller 56 to chipset 20. Thus, in an operational state, KVM appliance 40, keyboard 42 and mouse 44 are logically and directly accessible by the host BIOS and operating system in essentially a conventional manner. The composite human interface device (HID) emulation is already done for the remote keyboard and mouse functions.

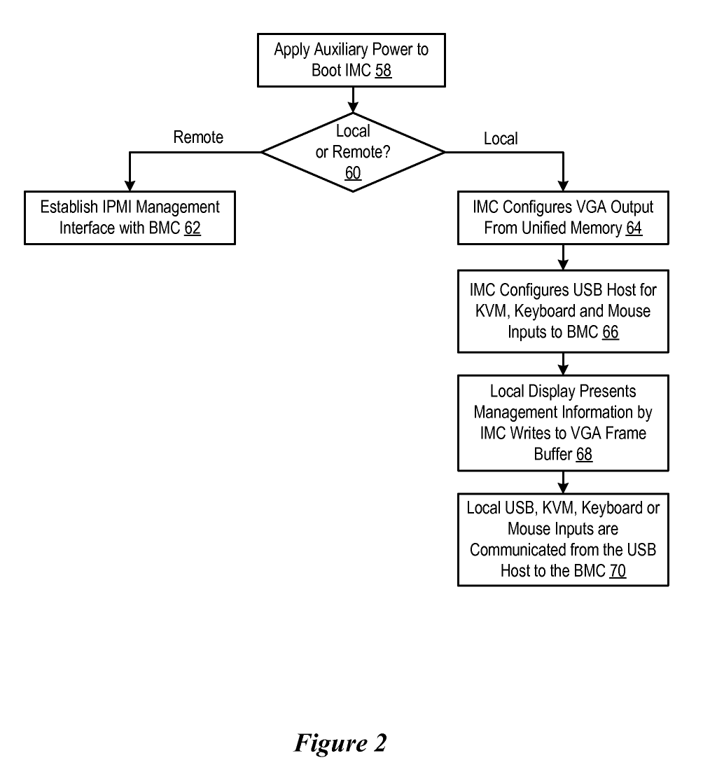

Referring now to FIG. 2, a flow diagram depicts a process for selectively interfacing the local or remote I/O devices with the server information handling system in the powered down state. The process begins at step 58 with application of auxiliary power to boot the IMC. At step 60, a determination is made of whether management of the IMC is local or remote. If the management of the IMC is remote, the process continues to step 62 to establish a management interface with IPMI through the BMC and out-of-band network interface. If the management of the IMC is local, the process continues to step 64 for the IMC to configure the output of its VGA core to originate from the unified memory so that management information written by the BMC to the unified memory will be presented at a local display interfaced with the VGA core. At step 66, the IMC configures its USB host to accept KVM, keyboard and mouse inputs as management information forwarded to the BMC. At step 68, a local display interfaced with the IMC VGA core presents management information by BMC writes to the VGA frame buffer at the unified memory. At step 70, local USB KVM appliance, keyboard or mouse inputs to the USB connector are communicated from the USB host of the IMC to the BMC to be written as management information to the VGA frame buffer for presentation at the local display.

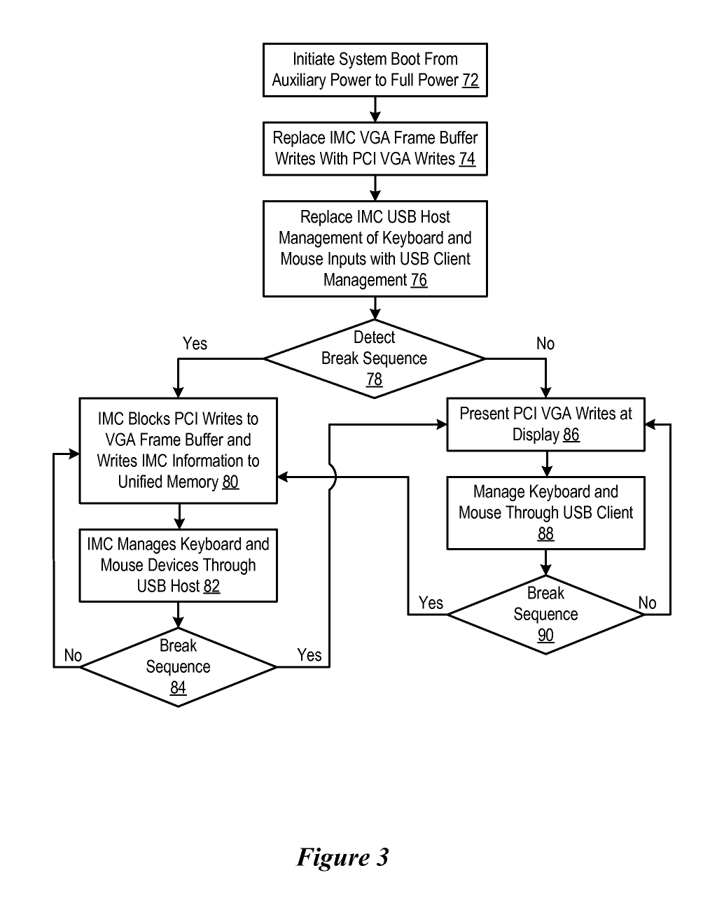

Referring now to FIG. 3, a flow diagram depicts a process for selectively interfacing the integrated management controller or the server information handling system with I/O devices with the server information handling system in an operational state. At step 72, the server information handling system boot is initiated with a transition from auxiliary to full primary power. At step 74, the IMC VGA frame buffer writes are replaced with PCI VGA writes under the direction of the server information handling system CPU. At step 76, IMC USB host management of keyboard, KVM and mouse inputs is replaced by USB client management with the forwarding of inputs to the IMC USB host to the IMC USB client. At step 78, with the server information handling system I/O devices under CPU management, inputs at the devices through the IMC USB host are snooped to detect a break sequence. If a break sequence is detected, the process continues to step 80 to transition from CPU management of I/O devices to IMC management while, if the break sequence is not detected the process continues to step 86 to continue CPU management. At step 80, the IMC blocks PCI writes to the VGA frame buffer and writes IMC information to unified memory. At step 82, the IMC manages keyboard and mouse device inputs through the USB host to the BMC so that inputs are handled by the BMC and presented at the local display. At step 84, a break sequence is again snooped with a lack of a break sequence continuing IMC management of local I/O devices at step 80 and the presence of a break sequence resulting to transition to CPU management at step 86. At step 86, PCI VGA writes are presented at the local display as output under management of the CPU. At step 88, keyboard and mouse inputs are managed by forwarding from the IMC USB host to the USB client for use at the CPU. At step 90, a break sequence is snooped so that presence of a break sequence results in IMC management of I/O devices at step 80 and absence of a break sequence continues CPU management.

Although the present invention has been described in detail, it should be understood that various changes, substitutions and alterations can be made hereto without departing from the spirit and scope of the invention as defined by the appended claims.

What is claimed is:

1. A server information handling system comprising:
a central processing unit operable to process network information;
plural network interface cards interfaced with the central processing unit and operable to communicate the network information with a network;
an integrated management controller having a baseboard management controller operable to perform management functions in a powered down state and to communicate management information with an I/O device, a network interface operable to support network remote sessions between the baseboard management controller and a network, and one or more I/O device modules operable to interface with I/O devices; and
an I/O device manager associated with the integrated management controller, the I/O device manager operable to selectively interface the network remote session or the I/O device modules with the baseboard management controller to communicate the management information with the I/O device.

2. The server information handling system of claim 1 wherein the I/O device module comprises a USB host and a USB client, the USB host operable to accept I/O device inputs and to forward the I/O device inputs to the baseboard management controller or the USB client.

3. The server information handling system of claim 2 wherein the I/O device comprises a keyboard.

4. The server information handling system of claim 2 wherein the I/O device comprises a mouse.

5. The server information handling system of claim 2 wherein the I/O device comprises a KVM appliance.

6. The server information handling system of claim 1 wherein the I/O device module comprises a display module operable to operable to communicate the management information to a display.

7. The server information handling system of claim 6 further comprising:
memory operable to store information; and
a memory controller integrated in the integrated management controller and interfaced with the baseboard management controller and the display module, the baseboard management controller communicating the management information to the display module by having the management controller store the management information in the memory for retrieval by the display module.

8. The server information handling system of claim 7 wherein the I/O device manager is further operable to monitor for a break signal during a powered up state, the break signal interrupting presentation of information at the display to present management information from the baseboard management controller.

9. A server information handling system integrated management controller comprising:
a baseboard management controller operable to perform management functions for a server information handling system in a powered down state, the management functions supported with management information communicated with an I/O device;
an I/O device module interfaced with the baseboard management controller and operable to support communication of the management information between the baseboard management controller and the I/O device; and
an I/O device manager operable to selectively interface the I/O device with the baseboard management controller based on one or more predetermined factors.

10. The server information handling system integrated management controller of claim 9 wherein the predetermined factors comprise the existence of a remote management console session by the baseboard management controller through a network.

11. The server information handling system integrated management controller of claim 9 wherein the predetermined factors comprise a break signal received at the baseboard management controller, the break signal commanding alternating interfaces of the I/O device with the baseboard management controller and the server information handling system.

12. The server information handling system integrated management controller of claim 9 wherein the I/O device module comprises a display module for generating visual information, the server information handling system integrated management controller further comprises a memory controller interfaced with the baseboard management controller, the display module and a unified memory, the baseboard management controller communicating the management information to the display module by writes to the unified memory.

13. The server information handling system integrated management controller of claim 9 wherein the I/O device module comprises a USB host interfaced with the baseboard management controller and a USB client interfaced with the USB host, the I/O device manager interfacing I/O devices with the baseboard management controller through the USB host and interfacing I/O devices with the server information handling system by forwarding inputs from the USB host to the USB client.

14. A method for management of a server information handling system in a power down state, the method comprising:
providing auxiliary power to an integrated management controller;
establishing one or more management functions on a baseboard management controller of the integrated management controller;
determining whether an user interface with the baseboard management controller exists through a network remote console session or through a local I/O device; and
selectively communicating management information between the baseboard management controller and the determined network remote console session or local I/O device.

15. The method of claim 14 wherein selectively communicating management information further comprises:
communicating management information from the baseboard management controller to a unified memory;
accessing the management information from the unified memory with a display module; and
presenting the management information from the display module to a local display.

16. The method of claim 14 wherein selectively communicating management information further comprises:
communicating management information from a local USB connection to a USB host; and
providing the management information from the USB host to the baseboard management controller.

17. The method of claim 16 further comprising:
detecting a transition of the server information handling system from the powered down state to an operational state; and
forwarding the management information from the USB host to a USB client for use by the server information handling system.

18. The method of claim 17 further comprising:
forwarding management information from the baseboard management controller to a display module through writes by the baseboard management controller to a unified memory accessed by the display module; and
interrupting the forwarding of the management information to the display module upon the detecting a transition of the server information handling system from the powered down state to an operational state.

19. The method claim 18 further comprising:
detecting a break sequence input at the USB host;
interrupting the forwarding of the management information from the USB host to the USB client;
resuming the providing of the management information from the USB host to the baseboard management controller; and
resuming the forwarding of the management information from the baseboard management controller to the display module.

20. The method of claim 19 wherein the management information from the USB host comprises end user inputs through a KVM appliance.
